(19) United States
(12) Patent Application Publication
(10) Pub. No.: US 2011/0288784 A1
(43) Pub. Date: Nov. 24, 2011

(54) Monitoring Energy Expended by an Individual

(75) Inventors: Jeetendra Jangle, Fremont, CA (US); Rajendra Moreshwar Sapre, Pune (IN)

(73) Assignee: WELLCORE CORPORATION, San Jose, CA (US)

(21) Appl. No.: 13/204,658

(22) Filed: Aug. 6, 2011

Related U.S. Application Data
(63) Continuation-in-part of application No. 12/560,069, filed on Sep. 15, 2009.
(60) Provisional application No. 61/208,344, filed on Feb. 23, 2009.

(51) Int. Cl. G06F 19/00

(52) U.S. Cl. 702/19

(57) ABSTRACT

Methods, apparatuses and systems of monitoring energy expended by an individual are disclosed. One method includes sensing, by a motion sensor, motion of the individual, identifying a plurality of activities performed by the individual over a period of time based on the identified motions, estimating, by a processor, energy expended by the individual for each of the plurality of the plurality of identified activities, and estimating energy expended by the individual by summing the estimated energy expended for each of the plurality of activities.

### RELATED APPLICATIONS

This patent application is a continuation-in-part (CIP) of U.S. patent application Ser. No. 12/560,069, filed on Sep. 15, 2009, which claims priority to US provisional patent application Ser. No. 61/208,344 filed on Feb. 23, 2009 which is incorporated by reference.

### FIELD OF THE DESCRIBED EMBODIMENTS

The described embodiments relate generally to motion detecting. More particularly, the described embodiments relate to a method and apparatus of motion detecting and monitoring of energy expended by an individual.

### BACKGROUND

There is an increasing need for remote monitoring of individuals, animals and inanimate objects in their daily or natural habitats. Many seniors live independently and need to have their safety and wellness tracked. A large percentage of society is fitness conscious, and desire to have, for example, workouts and exercise regimen assessed. Public safety officers, such as police and firemen, encounter hazardous situations on a frequent basis, and need their movements, activities and location to be mapped out precisely.

The value in such knowledge is enormous. Physicians, for example, like to know their patients sleeping patterns so they can treat sleep disorders. A senior living independently wants peace of mind that if he has a fall it will be detected automatically and help summoned immediately. A fitness enthusiast wants to track her daily workout routine, capturing the various types of exercises, intensity, duration and caloric burn. A caregiver wants to know that her father is living an active, healthy lifestyle and taking his daily walks. The police would like to know instantly when someone has been involved in a car collision, and whether the victims are moving or not.

Existing products for the detection of animate and inanimate motions are simplistic in nature, and incapable of interpreting anything more than simple atomic movements, such as jolts, changes in orientation and the like. It is not possible to draw reliable conclusions about human behavior from these simplistic assessments.

It is desirable to have an apparatuses and methods that can accurately monitor activity and energy expended by an individual.

### SUMMARY

An embodiment includes a method of monitoring energy expended by an individual. The method includes sensing, by a motion sensor, motion of the individual, identifying a plurality of activities performed by the individual over a period of time based on the identified motions, estimating, by a processor, energy expended by the individual for each of the plurality of the plurality of identified activities, and estimating energy expended by the individual by summing the estimated energy expended for each of the plurality of activities.

Another embodiment includes an apparatus for monitoring energy expended by an individual. The apparatus includes at least one acceleration sensing device sensing acceleration of the individual, an artificial neural network receiving the sensed acceleration, accessing stored coefficients, and identifying at least one activity of the individual. A controller is operative to estimate energy expended by the individual for each of the plurality of identified activities, and estimate energy expended by the individual by summing the estimated energy expended for each of the plurality of activities.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a block diagram of an embodiment of a device for monitoring energy expended by an individual.

FIG. 2 shows a representation of an artificial neural network.

FIG. 3 shows a block diagram of another embodiment of a device for monitoring energy expended by an individual.

FIG. 4 is a flowchart that includes the steps of an example of a method of monitoring energy expended by an individual.

FIG. 5 is a flowchart that includes the steps of a method of training an artificial neural network (ANN) so as to enable identification of an activity of the individual.

FIG. 6 is a flowchart that includes the steps of a method of identifying an activity of the individual using artificial neural network (ANN) based discriminator.

FIG. 7 is a flowchart that includes the steps of a method of calculating a caloric burn of the individual and estimating a weight change target.

FIG. 8 is a flowchart that includes the steps of another method of identifying activities of the individual.

FIG. 9 is a functional block diagram of an embodiment for generating coefficients (training mode) for the artificial neural network.

FIG. 10 is a functional block diagram of an embodiment for identifying activities of the individual, and further, estimating achievement of a fitness target.

FIG. 11 shows an activity detection device that can be connected to one of multiple networks.

### DETAILED DESCRIPTION

The monitoring of human physical activities generally falls into three categories: safety, daily lifestyle, and fitness. Physical activity can be defined as body movement that results in energy expenditure. Physical activity is a complex behavior as it can include sports and non-sports activities. Sports are often planned, structured, and repetitive, with the objective of improving or maintaining physical fitness, whereas non-sports activities can be subdivided into different categories such as occupational, leisure-time, and household activities but also personal care and transportation. Clearly, physical activity has an impact on energy expenditure. Additionally, energy expenditure is dependent on body size and body composition of the individual.

The monitoring of physical activity and the resulting expended energy provides a useful method for determining an activity level of the life style of the individual. Estimating the energy expenditure over periods of time can assist the individual with managing caloric expenditure, which can be used to aid the individual with caloric consumption management. For embodiments, the caloric consumption is computed based on the metabolic equivalent (MET)×Mass (Weights in kg) of the person×time duration in minutes, wherein the MET value may be derived with reasonable accuracy based on the activity identified, and some of its derivable attributes from the acceleration data (like walking steps or cadence during biking) and augmented with the supplementary data like the slope of the path traversed during walking or resistance settings of the equipment.

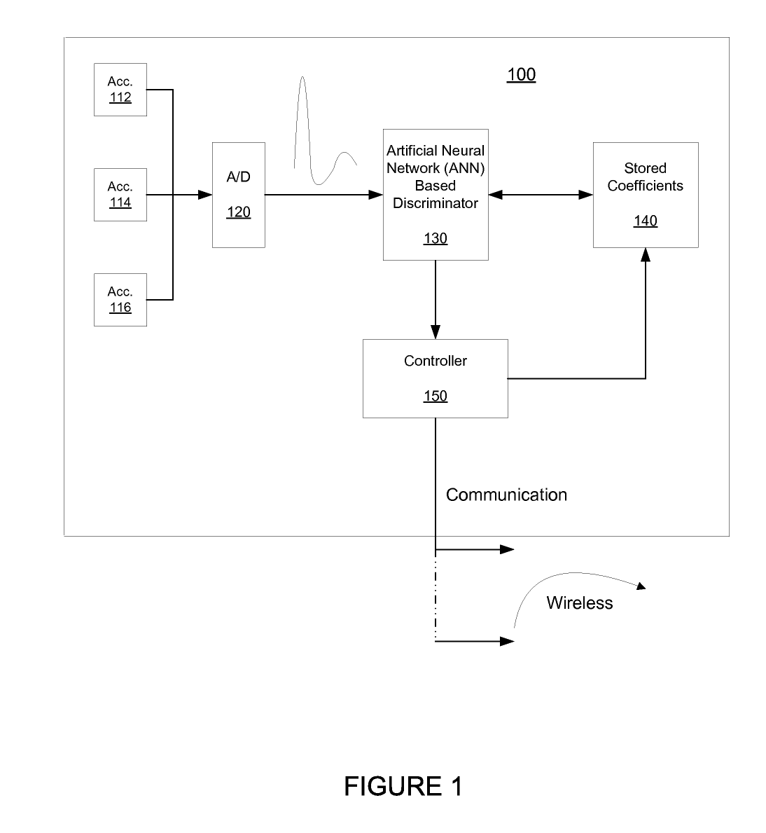

FIG. 1 shows a block diagram of an embodiment of a device 100 for monitoring energy expended by an individual. The device 100 can be attached to an individual, and therefore, detect motion of the individual. The detected motion can be used to identify activities performed by the individual. Energy expended by the individual for each identified activity can be estimated. The energy expended by the individual for a period of time can be determined by summing the estimated energy expended by each activity identified over the period of time.

An embodiment of the device 100 includes sensors (such as, accelerometers) that detect motion of the object. One embodiment of the sensors includes accelerometers 112, 114, 116 that can sense, for example, acceleration of the device (and therefore, the individual) in X, Y and Z directional orientations. It is to be understood that other types of motion detection sensors can alternatively be used.

For this embodiment, an analog to digital converter (ADC) 120 digitizes analog accelerometer signals. The digitized signals are received by an artificial neural network (ANN) based discriminator 130, which identifies activities of the individual based on the sensed motion, and stored coefficients 140. A controller 150 computes the calorific burn based on the duration of the activity as well as based on certain additional information like number of steps (in the case of walk).

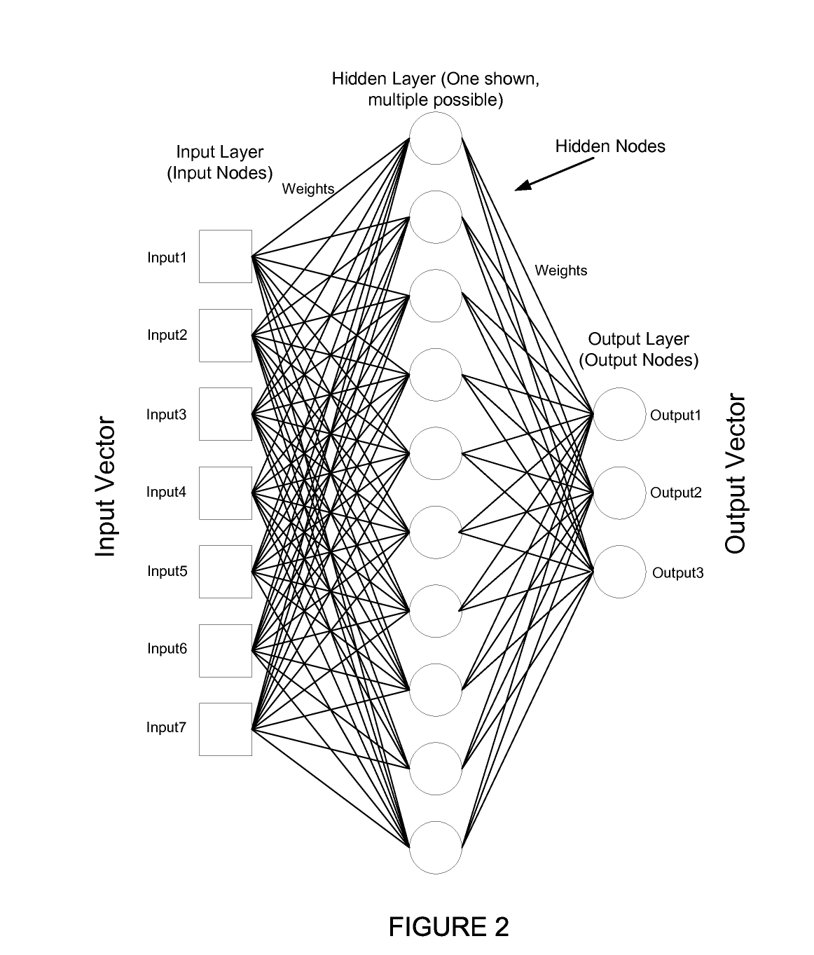

An embodiment of the ANN based discriminator 130 includes a neural network that includes an input layer, one-or-more hidden layers, and an output layer. FIG. 2 shows a representation of an artificial neural network that includes an input layer (that includes input nodes) a hidden layer (that includes hidden nodes) and an output layer (that includes output nodes). The representation of FIG. 2 only includes one hidden layer, but it is to be understood that there can be multiple hidden layers. Nodes of each layer feed the next layer with an associated weighting (coefficient). The set of inputs (Input1-Input7) define an input vector, and the set of outputs (Output1-Output3) define an output vector. Clearly, each layer (input, one or more hidden, and output) can include any number of nodes.

Each node of the input layer is connected to each node of the hidden layer through a link that includes an associated weight. Each node of each layer is only connected to nodes of the next immediate layer. The outputs of the nodes in the output layer provide a decision or recognition in the form of the output vector. Each node determines a weighted sum of the individual inputs that are connected to it from the previous layer. This sum is then fed to an activation function or a sigmoid function (which is within the node, and typically includes an S shaped relation between input and the output). For and embodiment, the activation function generates an output in the range of 0 to 1 from the weighted sum.

The learning capability of the neural network is essentially captured in the inter-connecting weights—which form the coefficients of the neural network. In the case of a neural network of one hidden layer, the learning capability is enabled by adaptation of the coefficients (weights) of an input matrix and an output matrix. During the training process, then ANN is presented with a set of input and output vectors. The coefficients of ANN are adjusted incrementally, so as to match the output vector with the expected output vector.

In execution mode, a trained ANN is able to recognize the output vector from the input vector. This approach is particularly useful when it is not possible to arrive at a firm mathematical relationship between input vectors and output vectors. This is typically the case when the outputs are defined by randomly shaped multiple potentially overlapping clusters within the multidimensional space of input vectors. Additionally, the ANNs may possess an ability to recognize with reasonable accuracy, the correct output corresponding to an unseen input vector.

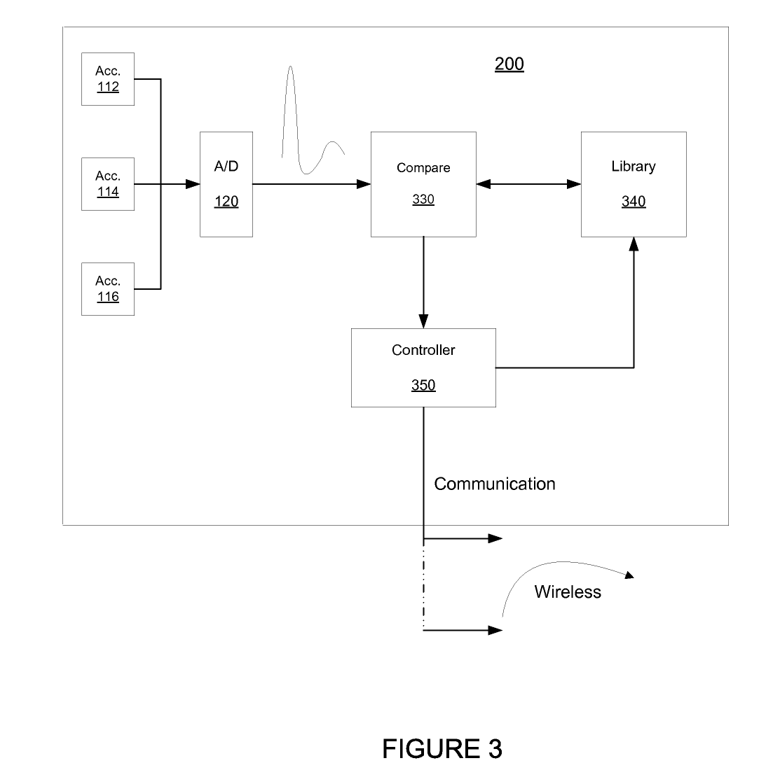

FIG. 3 shows a block diagram of another embodiment of a device 300 for monitoring energy expended by an individual. For this embodiment, the digitized signals of the ADCs 112, 114, 116 are received by compare processing circuitry 330 that compares the digitized accelerometer signals with signatures that have been stored within a library of signatures 340. Each signature corresponds with a type of motion. Therefore, when a match between the digitized accelerometer signals and a signature stored in the library 340, the type of motion experienced by the motion detection device can determined.

An embodiment includes filtering the accelerometer signals before attempting to match the signatures. Additionally, the matching process can be made simpler by reducing the possible signature matches.

An embodiment includes identifying a previous human activity context. That is, for example, by knowing that the previous human activity was walking, certain signatures can intelligently be eliminated from the possible matches of the present activity that occurs subsequent to the previous human activity (walking)

An embodiment includes additionally reducing the number of possible signature matches by performing a time-domain analysis on the accelerometer signal. The time-domain analysis can be used to identify a transient or steady-state signature of the accelerometer signal. That is, for example, a walk may have a prominent steady-state signature, whereas a fall may have a prominent transient signature. Identification of the transient or steady-state signature of the accelerometer signal can further reduce or eliminate the number of possible signature matches, and therefore, make the task of matching the accelerometer signature with a signature within the library of signature simpler, and easier to accomplish. More specifically, the required signal processing is simpler, easier, and requires less computing power.

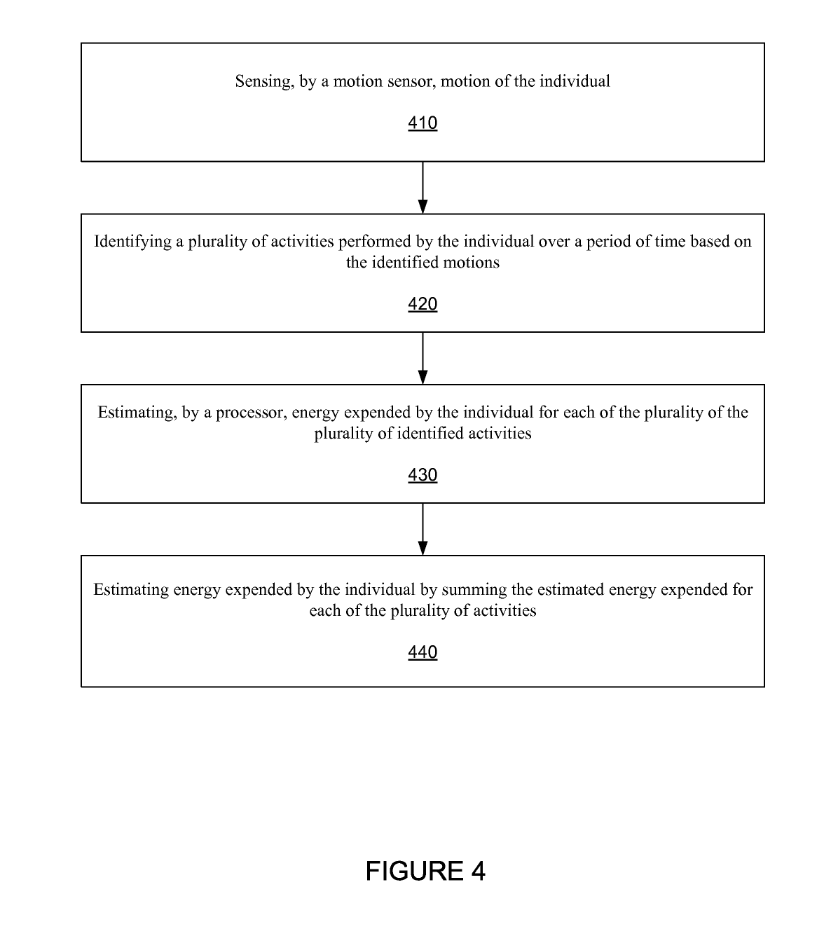

FIG. 4 is a flowchart that includes the steps of an example of a method of monitoring energy expended by an individual. A first step 410 includes sensing, by a motion sensor, motion of the individual. A second step 420 includes identifying a plurality of activities performed by the individual over a period of time based on the identified motions. A third step 430 includes estimating, by a processor, energy expended by the individual for each of the plurality of the plurality of identified activities. A fourth step 440 includes estimating energy expended by the individual by summing the estimated energy expended for each of the plurality of activities. As will be shown and described, the motion sensor can include one or more motion sensors (such as, an accelerometer) that sense, for example, different directions of motion. The processor can include one or more processors. For example, in one embodiment the processor is within a stand-alone unit that can be worn by the individual. In other embodiments, the processor is at least partially separately located (including being entirely separately located) and is networked (for example, wirelessly) to the motion sensing device. That is, the processing can be partially performed locally within the motion detection/sensing device, and be partially performed non-locally to the motion detection/sensing device.

Activity Identification

For an embodiment, identifying a plurality of activities includes identifying a quasi-periodic activity. For embodiments, this identification includes a training mode wherein motion is sensed while the individual performs a known activity. For embodiments, the training mode includes generating ANN coefficients that are specific to a group of individuals sharing a common body profile and/or age group and/or activity level. The quasi-periodic activity can be identified based upon sensing motion of the individual, and the trained coefficient.

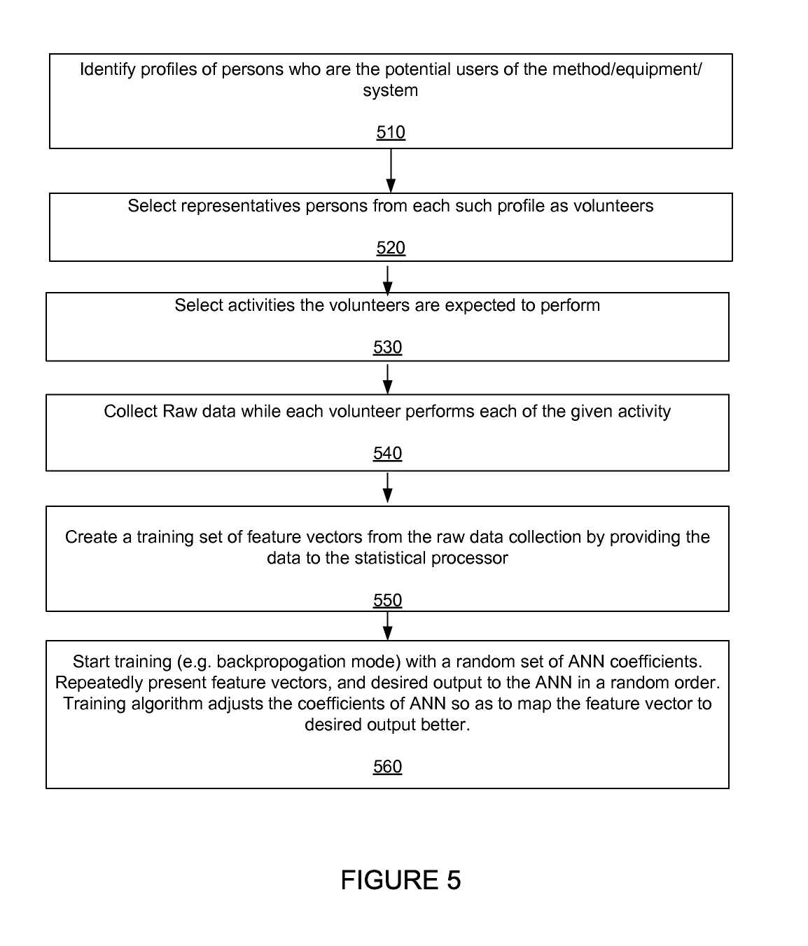

FIG. 5 is a flowchart that includes an example a method of training of ANN. A first step 510 includes identify profiles of individuals who are the target users. A second step 520 includes choosing a plurality of volunteers that represent a given profile. A third step 530 includes listing the activities the volunteers are supposed to perform. A forth step 540 includes collecting raw samples of data while each of the volunteer performs the given activity. A fifth step 550 includes providing the raw data samples to a statistical processor (which acts as a feature extractor) to produce the feature vectors. A sixth step 560 includes beginning the training mode (for example using back propagation algorithm)—where the ANN is initialized with a random set of coefficients.

For an embodiment, the ANN coefficients are repeatedly tested in a random order. The ANN is provided with a pair of input/output vectors. More specifically, a feature input vector and a corresponding desired output vector (based on the activity tagging) are provided to the ANN. A training algorithm adjusts the coefficients of the ANN in such a manner that the overall difference between actual vector outputs and the desired vector outputs are minimized. This procedure is repeated until the coefficients of ANN converge to the desired training set (a trained set of coefficients). In such a condition, for most of the feature input vectors, the output vector produced by the ANN matches with the desired output.

Embodiments further include an execution mode in which the trained ANN coefficients are used to indentify motions and activities. That is, raw data from, for example, the accelerometer is provided to the statistical processor which generates a feature input vector. The generated feature input vector is provided to the trained ANN, which indentifies the motion and/or activity by matching the feature input vector with a known output vector.

In some situations, the activity cannot be identified by the stored ANN coefficients. Accordingly, for some embodiments, if the activity cannot be identified based on the ANN coefficients, the unidentified activity is tagged as a new activity, and the ANN coefficients are updated to support the identification of that activity in the future. For this change to take place, the training activity may be performed by augmenting a new pair that includes a feature vector and a correspondingly tagged new output vector that correspond to the newly identified activity.

For embodiments, identifying quasi-periodic activity further includes generating an acceleration signature based on sensed acceleration of the individual, and identifying the type of motion of the individual based on discrimination of the acceleration signature using a training set that was generated during the training mode.

For an embodiment, identifying quasi-periodic activity includes generating an acceleration signature based on sensed acceleration of the individual, matching the acceleration signature with at least one of a plurality of stored acceleration signatures, wherein each stored acceleration signatures corresponds with a type of motion, and identifying the type of motion of the object based on the matching of the acceleration signature with a stored acceleration signature. The type of motion can include, for example, at least one of atomic motion, elemental motion and macro-motion. For an embodiment, the stored acceleration signatures are stored in a common library and a specific library, and matching the acceleration signature comprises matching the acceleration signature with stored acceleration signatures of the common library, and then matching the acceleration signature with stored acceleration signatures of the specific library.

For embodiments, identifying a plurality of activities includes identifying at least one non-quasi-periodic activity, including sensing an intensity and direction of the non-quasi-periodic activity.

For embodiments, estimating energy expended by the individual for each of the plurality of identified activities includes estimating the energy expended based on at least one of a quasi-periodicity of the activity, an intensity of the activity and a deviation of an acceleration magnitude from its moving average value.

For embodiments, estimating the energy expended by the individual for each of the plurality of identified activities includes estimating energy expended based on at least one of static orientation of the individual, a change of orientation of the individual, a time taken to change the orientation of the individual, and a number of times the orientation changes within a given amount of time. For embodiments, estimating the energy expended by the individual for each of the plurality of activities includes estimating energy expended based on statistical properties (mean deviation, average, etc.) of an acceleration vector along a plurality of axes of orientation.

Embodiments include calculating a caloric burn of the individual based on the estimated energy expended. Embodiments further include estimating caloric intake of the individual. Further, the caloric burn of the individual can be compared with the caloric intake of the individual, and estimating a weight change per unit time. Embodiments further include estimating a period required to meet a specific weight change target based on a weight change per unit time.

An embodiment includes a quasi-periodic activity through execution of a training mode wherein motion is sensed while the individual performs a known activity. Further, a personal profile is generated for the individual, wherein the profile comprises a plurality of parameters that are personalized to the individual. Embodiments include identifying the quasi-periodic activity based upon sensing motion of the individual, and profile. If the activity cannot be identified based on the profile, the unidentified activity is tagged as a new activity, and the profile is updated to include corresponding parameters that are personalized to the individual.

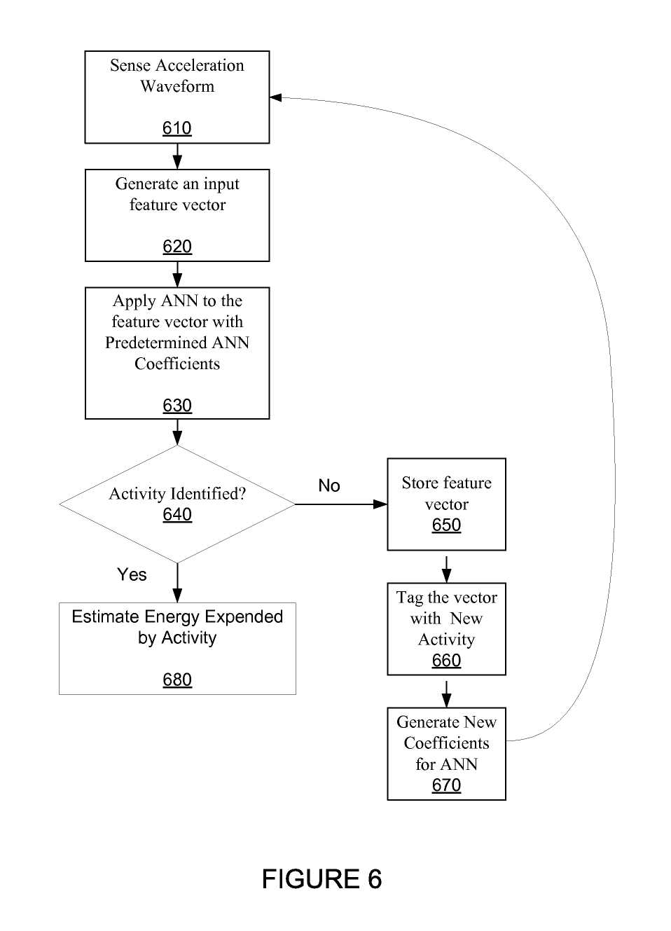

FIG. 6 is a flowchart that includes the steps of a method of identifying an activity of the individual using an Artificial Neural Network (ANN). A first step 610 includes sensing an acceleration waveform. For other embodiments, other types of sensor can be sensed. For example, heart rate monitor may provide a complimentary data to the acceleration sensor data. A second step 620 includes generating an acceleration signature (which can be in the form of an input feature vector) based on the sensed acceleration. A third steps 630 includes applying an ANN to the acceleration signature (the input feature vector) with predetermined ANN coefficients. If the activity of the individual is identified (step 640) then a step 680 includes estimating energy expended by the activity.

If the activity could not be identified (step 640) a step 650 includes storing the newly detected activity, a step 660 includes tagging the new activity (feature vector), and a step 670 includes generating new coefficients for the artificial neural network.

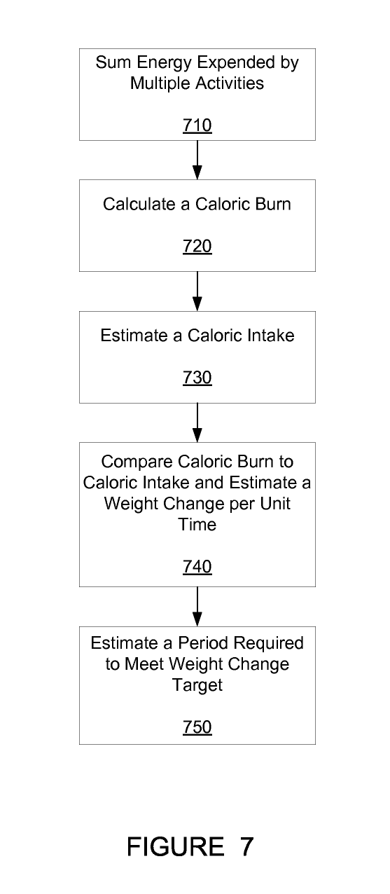

FIG. 7 is a flowchart that includes the steps of a method of calculating a caloric burn of the individual and estimating a weight change target. Once one or more activities have been identified, a step 710 includes summing estimated energy expended for multiple activities. From the estimated energy expenditure, a step 720 includes calculating a caloric burn of the individual during the identified activities. A step 730 includes estimating a caloric intake of the individual. A step 740 includes comparing the caloric burn to the caloric intake and estimating a weight change per unit time for the individual. A step 750 includes estimating a time period required to meet a weight change target of the individual.

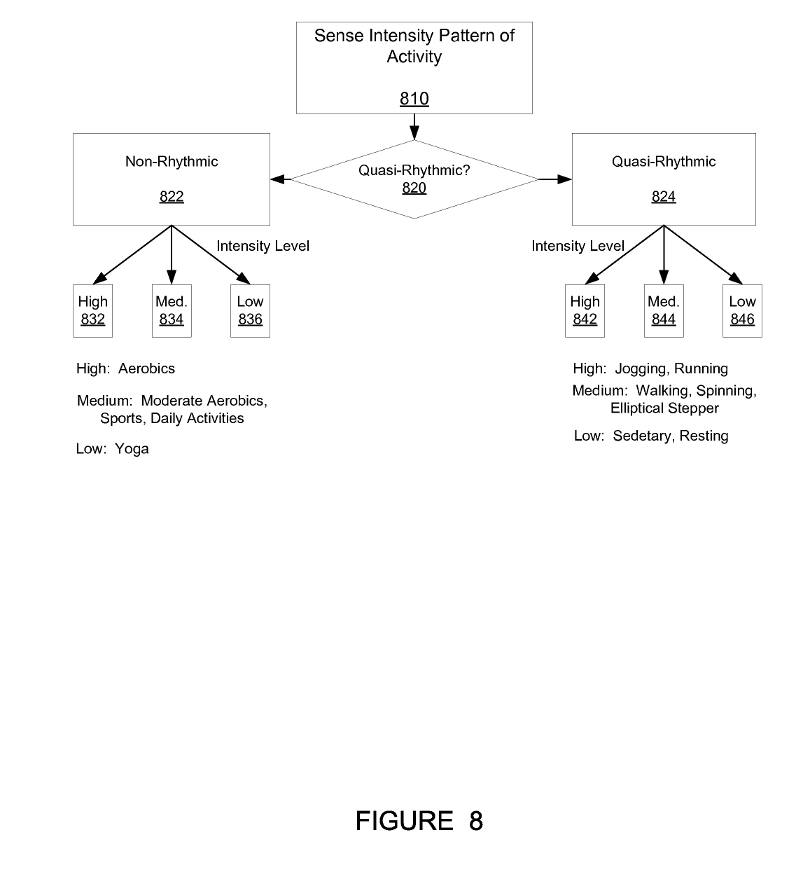

FIG. 8 is a flowchart that includes the steps of another method of identifying activities of the individual. A first step 810 includes an initial sensing of levels of intensity of the activity. Monitoring over a period of time allows determination (step 820) of whether the activity is quasi-rhythmic or non-rhythmic. This can be determined, for example, by monitoring change of orientation or by monitoring shift in the energy content across plural axes within a short period of time.

If determined to be non-rhythmic, a step 822 is executed that includes determining (detecting) a level of intensity of the activity. This can be accomplished, for example, by sensing the intensity of the sensed acceleration of the individual. If determined to be non-rhythmic, and of high intensity (832), it can be deduced, for example, that the activity is a form of aerobics. If determined to be non-rhythmic, and of medium intensity (834), it can be deduced, for example, that the activity is a form of moderate aerobics, sports or some other identified daily activities. If determined to be non-rhythmic, and of low intensity (836), it can be deduced, for example, that the activity is a form of yoga.

If determined to be quasi-rhythmic, a step 824 is executed that includes determining (detecting) an intensity level of the activity. This can be accomplished, for example, by sensing the intensity of the sensed acceleration of the individual. If determined to be rhythmic, and of high intensity (842), it can be deduced, for example, that the activity is a form of jogging or running If determined to be rhythmic, and of medium intensity (844), it can be deduced, for example, that the activity is a form of walking, spinning or elliptical spinning If determined to be rhythmic, and of low intensity (846), it can be deduced, for example, that the activity is sedentary or resting.

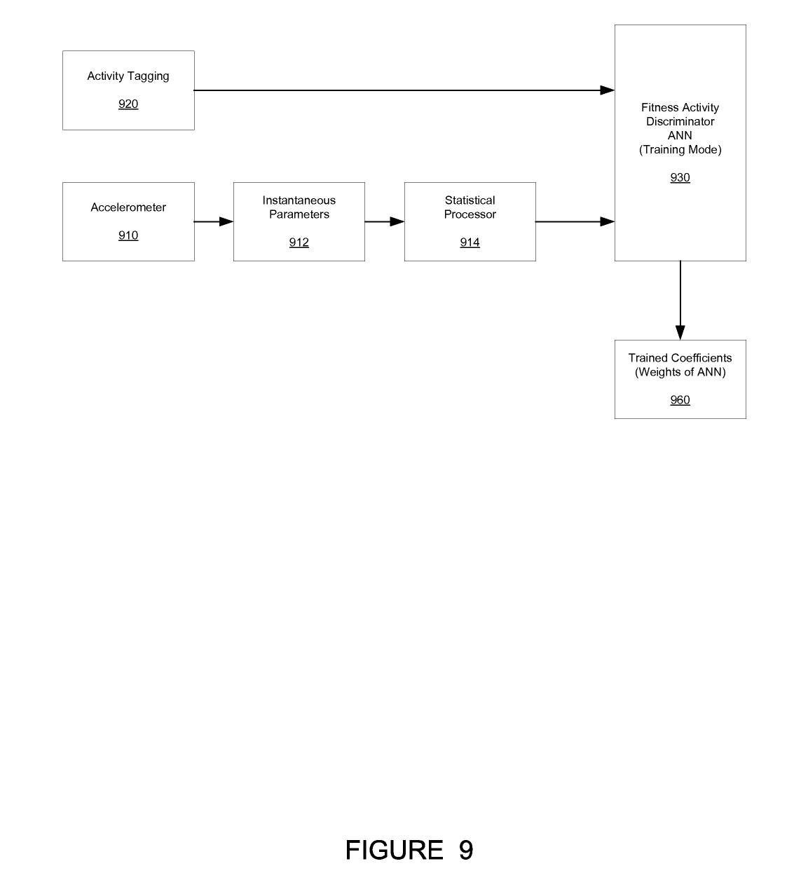

FIG. 9 is a functional block diagram of an embodiment for generating coefficients (training mode) for the artificial neural network. As described, embodiments include a training mode and an execution mode.

For embodiments, the training mode includes a supervised mode in which training coefficients are generated. The system is trained, for example, with variety of inputs from individuals with different body profile and age groups, while the individual is performing different pre-defined activities, with sensor (such as the previously described accelerometers) connected to different pre-determined body locations.

The raw data generated by the sensors can be recorded and data sets tagged (912) with an activity code, speed/vigor level code, and optionally, with sensor location, and specific details about the person's profile or the details of any fitness equipment settings.

For an embodiment, accelerometer 910 outputs are obtained as raw data which is fed to an instantaneous parameters generator 912. The instantaneous data vectors generated by the instantaneous parameters generator 912 are fed to statistical processor 914. For embodiments, the statistical processor 914 acts on a frame of consecutive N points and provides frame-feature-vectors as outputs.

For an embodiment, the feature vector comprises of a set of numbers that describes some properties of the frame. For example, the common statistical properties like average, standard-deviation, maximum value, form a description of the larger number set of N consecutive points of the frame. Feature set is chosen so as to create maximum differentiation between the different activities the person may perform.

For an embodiment, outputs of an entire training data set are collected together and the overall range of minimum-maximum (min-max range) values for each feature is computed. The min-max range is used to scale each feature within the vector into a fraction, for example, between 0.0 and 1.0. The min value maps to 0.0 while the max value maps to 1.0 and any value in between them maps to a proportional fraction in between. Scaling makes the values more compatible to the expected inputs of the ANN while retaining all the relevant contents of the data.

Training scripts extract the tagging details and feed those as output vectors to fitness activity discriminator. Scaled input feature vectors are also fed to a fitness activity discriminator 930.

The ANN (of the fitness activity discriminator 930) under training mode is repeatedly presented with, in a random sequence, one item at a time, from the training set that comprises an input feature vector, and the corresponding desired output vector. With sufficient iterations, the ANN is trained with entire set of available training data to produce trained ANN coefficients 960.

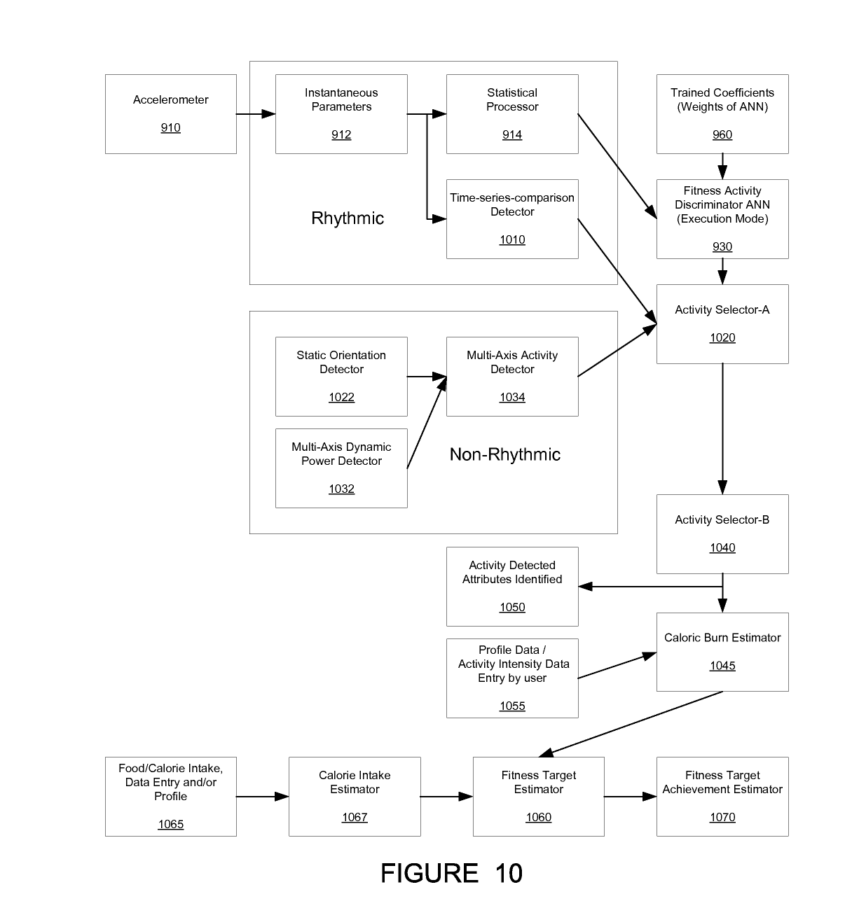

FIG. 10 is a functional block diagram of an embodiment for identifying activities of the individual, and further, estimating achievement of a fitness target. For the previously mentioned execution mode, an appropriate set of trained coefficients are pushed to user's sensor based on, for example, the user's profile selection. During execution mode, accelerometer 910 sends acceleration data to Instantaneous Parameters generator 920 which generates instantaneous data vectors. The instantaneous data vectors are fed to statistical processor 914. The statistical processor 914 operates on a frame of consecutive N points and provides frame-feature-vectors as outputs. Frame feature vectors are normalized to restrict their range between 0.0 and 1.0. Fitness discriminator ANN 930 is configured with trained coefficients. When feature vectors are fed to the fitness discriminator 930, the fitness discriminator 930 provides an estimate of fitness activity. The fitness discriminator 930 provides one number for each likely fitness activity. The fitness activity corresponding to the maximum output value is provided to an activity selector-A 1020.

A static orientation detector 1022 takes acceleration readings of individual axes and low-pass filters those to obtain a smooth static orientation. That is, the static orientation detector 1022 detects the prominent axis as well as the extent of relative orientation of the 3 axes.

A multi-axis dynamic power detector 1032 takes individual acceleration components as input and captures a relative energy content by determining the mean-deviation of most recent consecutive M data points. The multi-axis dynamic power detector 1032 reports the most dynamically active axis over a given duration.

Activity selectors 1020, 1040 provide two levels of decision making to identify an activity. At the first level, activity selector 1020 chooses one activity out of the activities like Run/Jog from time-series-comparator 1010 and other activities detected by Fitness activity discriminator ANN 930, and the multi-axis activity detector 1034. The activity selector 1020 uses a rule base to choose one of the several activities that may be reported simultaneously by different detectors.

At second level, the activity selector-B 1040 maintains a history of K previously detected activities. The activity selector-B 1040 identifies an activity based on the history of previously detected activities, and the currently identified activity. For example, the activity selector-B 1040 can declare the mode value of the series as a simplest algorithm. As a result the activity selector-B 1040 filters the spurious detection of a different activities interspersed in the prominently detected main activity made available as report 1050.

A calorific burn estimator 1045 receives activity details from the activity selector-B 1040 and a profile data and/or activity intensity data entry 1055 and produces an estimate of caloric burn during the activity. The user enters a food/calorie intake profile 1065 and calorie intake estimator 1067 converts the profile into a caloric intake. A fitness target estimator 1060 compares the caloric burn of the individual with the caloric intake of the individual, and estimates a weight change per unit time. It further estimates a period required to meet a specific weight change target based on a weight change per unit time. A fitness target achievement estimator 1070 provides an estimate of the user achievements towards the user's fitness targets.

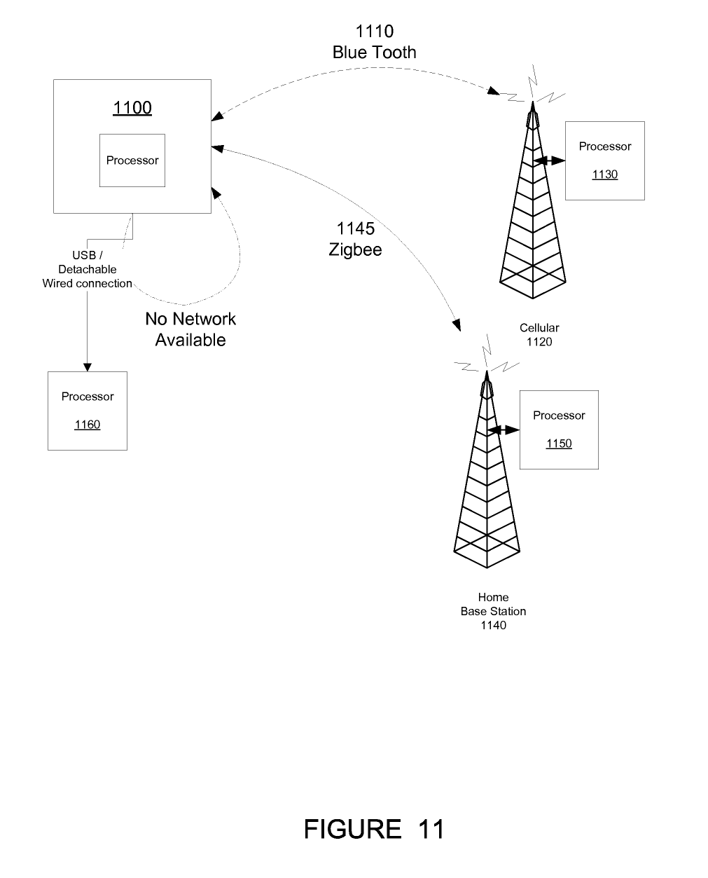

FIG. 11 shows an activity detection and energy consumption monitoring device 1100 that can be connected to one of multiple networks. Examples of possible networks (not a comprehensive list) the activity detection device 1100 can connect to, include a cellular network 1120 through, for example, a blue tooth wireless link 1110, or to a home base station 1140 through, for example, a ZigBee wireless link 1145. The wireless links 1110, 1145 can each provide different levels of bandwidth. Each of the networks includes available processing capabilities 1130, 1150.

If the motion activity detection device 1100 does not have any network connections available, the activity detection device 1100 must perform its own activity identification processing and energy consumption estimates. If this is the case, then the processing algorithms may be less complex to reduce processing power, and/or reduce processing speed. Acceleration signals data acquisition is performed in chunk of processing every few mili-seconds by waking up. For all other times the processor rests in low-power mode. Except for the emergency situation, the RF communication is done periodically when the data is in steady state, there is no need to send it to network i.e. when the object is in sedentary there is no need to send data change in the state is communicated to network. Additionally, if no network connections are available, the operation of the activity detection device 1100 may be altered.

The activity detection device 1100 includes a processor in which at least a portion of the analysis and signature matching can processing can be completed. However, if the activity detection device 1100 has one or more networks available to the motion detection activity detection device 1100, the motion detection device can off-load some of the processing to one of the processors 1130, 1150 associated with the networks.

The determination of whether to off-load the processing can be based on both the processing capabilities provided by available networks, and the data rates (bandwidth) provided by each of the available networks.

In another embodiment, the activity detection device 1100 may be connected to processor 1160 using a detachable wired connection, for example, USB. This processor 1160 may extract the motion detection information and optionally carry out part of the processing. Optionally, the wired connection is used for upgrading the firmware or the profile configuration information of the device 1100.

As shown and described, at least some of the embodiments described include method or processes that are operable on a machine, such as, a server or computer. Accordingly, at least some embodiments include a program storage device readable by such a machine, tangibly embodying a program of instructions executable by the machine to perform a method of monitoring energy expended by an individual. At least one embodiment of the method includes sensing motion of the individual, identifying a plurality of activities performed by the individual over a period of time based on the identified motions, estimating energy expended by the individual for each of the plurality of the plurality of identified activities, and estimating energy expended by the individual by summing the estimated energy expended for each of the plurality of activities.

Although specific embodiments have been described and illustrated, the embodiments are not to be limited to the specific forms or arrangements of parts so described and illustrated.

What is claimed:

1. A method of monitoring energy expended by an individual, comprising:
sensing, by a motion sensor, motion of the individual;
identifying a plurality of activities performed by the individual over a period of time based on the identified motions;
estimating, by a processor, energy expended by the individual for each of the plurality of the plurality of identified activities; and
estimating energy expended by the individual by summing the estimated energy expended for each of the plurality of activities.

2. The method of claim 1, wherein identifying a plurality of activities comprises identifying a quasi-periodic activity.

3. The method of claim 2, wherein identifying a quasi-periodic activity comprises a training mode wherein training coefficients are generated, by sensing motion with the motion sensor while the individual performs a known activity.

4. The method of claim 3, wherein the training mode comprises generating a personal profile for the individual, or for group of individuals, wherein the profile comprises a plurality of parameters that are personalized to the individual or to the group.

5. The method of claim 4, wherein the quasi-periodic activity is identified based upon sensing motion of the individual, and the training coefficients.

6. The method of claim 4, wherein if the activity cannot be identified based on the training coefficients, tagging the unidentified activity as a new activity, and updating the training coefficients to include corresponding parameters that are personalized to the individual or the individual's profile.

7. The method of claim 5, wherein identifying quasi-periodic activity further comprises:
generating an acceleration signature based on sensed acceleration of the individual,
matching the acceleration signature with at least one of a plurality of stored acceleration signatures, wherein each stored acceleration signatures corresponds with a type of motion;
identifying the type of motion of the object based on the matching of the acceleration signature with a stored acceleration signature.

8. The method of claim 7, wherein the type of motion comprises at least one of atomic motion, elemental motion and macro-motion.

9. The method of claim 7, wherein the stored acceleration signatures are stored in a common library and a specific library, and matching the acceleration signature comprises matching the acceleration signature with stored acceleration signatures of the common library, and then matching the acceleration signature with stored acceleration signatures of the specific library.

10. The method of claim 5, wherein identifying quasi-periodic activity further comprises:
generating an acceleration signature based on sensed acceleration of the individual,
identifying the type of motion of the individual based on discrimination of the acceleration signature using a training set, wherein the training set was generated during the training mode, and utilization of an artificial neural network.

11. The method of claim 1, wherein identifying a plurality of activities comprises identifying at least one non-quasi-periodic activity, comprising sensing an intensity and direction of the non-quasi-periodic activity.

12. The method of claim 1, wherein estimating energy expended by the individual for each of the plurality of identified activities comprise estimating the energy expended based on at least one of a quasi-periodicity of the activity, an intensity of the activity and a deviation of an acceleration magnitude from a base value.

13. The method of claim 1, wherein estimating the energy expended by the individual for each of the plurality of identified activities comprises estimating energy expended based on at least one of static orientation of the individual, a change of orientation of the individual, a time take to change the orientation of the individual, and a number of times the orientation changes within a given amount of time.

14. The method of claim 13, wherein estimating the energy expended by the individual for each of the plurality of activities comprises estimating energy expended based on statistical properties of an acceleration vector along a plurality of axes of orientation.

15. The method of claim 1, further comprising calculating a caloric burn of the individual based on the estimated energy expended.

16. The method of claim 15, further comprising estimating caloric intake of the individual.

17. The method of claim 16, further comprising comparing the caloric burn of the individual with the caloric intake of the individual, and estimating a weight change per unit time.

18. The method of claim 17, further comprising estimating a period required to meet a specific weight change target based on a weight change per unit time.

19. An apparatus for monitoring energy expended by an individual, comprising:
at least one motion sensing device sensing motion of the individual;
an artificial neural network receiving the sensed motion, accessing stored coefficients, and identifying at least one activity of the individual;
a controller operative to estimate energy expended by the individual for each of the plurality of identified activities, and estimate energy expended by the individual by summing the estimated energy expended for each of the plurality of activities.

20. The apparatus of claim 19, wherein identifying a plurality of activities comprises identifying a quasi-periodic activity.

21. The apparatus of claim 20, wherein identifying a quasi-periodic activity comprises a training mode wherein training coefficients are generated, by sensing motion with the motion sensor while the individual performs a known activity.

22. The apparatus of claim 21, wherein the training mode comprises generating a personal profile for the individual, or for group of individuals, wherein the profile comprises a plurality of parameters that are personalized to the individual or to the group.

23. The apparatus of claim 22, wherein the quasi-periodic activity is identified based upon sensing motion of the individual, and the training coefficients.
